(19) United States
(12) Patent Application Publication
(10) Pub. No.: US 2007/0264559 A1
(43) Pub. Date: Nov. 15, 2007

(54) LAYER LAMINATION INTEGRATED FUEL CELL

(76) Inventors: Tsang-Ming Chang, Taipei (TW); Chih-Jung Kao, Taipei (TW); Chun-Wei Pan, Taipei (TW); Wei-Li Huang, Taipei (TW)

Correspondence Address: G. LINK CO., LTD., 3550 BELL ROAD, MINOOKA, IL, 60447, US

(21) Appl. No.: 11/747,915

(22) Filed: May 13, 2007

(30) Foreign Application Priority Data
May 15, 2006 (TW) 095117173

(51) Int. Cl. H01M 8/02

(52) U.S. Cl. 429/38

(57) ABSTRACT

The present invention provides a layer lamination integrated fuel cell, which comprises: two sheets of one-sided cathode flow field boards, at least one sheet of two-sided cathode flow field board, at least one sheet of two-sided anode flow field board, and, at least one sheet of bipolar fuel cell boards; in which, the two sheets of one-sided cathode flow field boards are configured on the both outmost sides of the fuel cell; these two-sided cathode flow field boards, these two-sided anode flow field boards, and these bipolar fuel cell boards are configured between the fuel cell in separated layers. The side surfaces with the cathode configured on the outmost two sheets of bipolar fuel cell boards for the fuel cell are tightly bonded with two sheets of one-sided cathode flow field boards, respectively; and, the side surfaces with the cathode configured in layers on the other bipolar fuel cell boards for the fuel cell are tightly bonded with each sheet of two-sided cathode flow field board, respectively; and, the side surfaces with the anode for these layered bipolar fuel cells are tightly bonded with each sheet of two-sided anode flow field board, respectively.

### FIELD OF THE INVENTION

The present invention relates to a fuel cell, and particularly a layer lamination integrated fuel cell.

### BACKGROUND OF THE INVENTION

The conventional plate-type fuel cell is limited to the limitation of the structure itself, such as the conventional direct methanol fuel cell, so if it is required to increase the power output, it must change the internal structure, and, not only increasing the number of membrane electrode assemblies for direct methanol fuel cell, but also the other associated compositions, such as flow field, all have to be changed accordingly. Thus, the manner for a slight move in one part affecting the whole situation was the major defect.

Another method is to have series/parallel connection for the positive and negative poles of each independent conventional fuel cell. Although this method could achieve increasing the output of overall power, each independent conventional fuel cell has its own original composition, such as fuel storage tank, that the entire volume of fuel cells in series/parallel connection is obviously too large, which becomes the major defect of this method.

In order to overcome the above-mentioned defects of the conventional methods, the conventional stacked fuel cell was designed out. The typical cases of such designs have been disclosed in the prior American Patent No. U.S. Pat. No. 5,200,278, U.S. Pat. No. 5,252,410, U.S. Pat. No. 5,360,679, and U.S. Pat. No. 6,030,718. Although the fuel cells fabricated with these prior arts might have higher power generation efficiency, their composition was rather complicated, and not easy to manufacture, and had higher cost, and higher requirement for the peripheral associated systems.

Another type of conventional plane-type fuel cell was also designed out. The typical cases of such design have been disclosed in the prior American Patent No. U.S. Pat. No. 5,631,099, U.S. Pat. No. 5,759,712, U.S. Pat. No. 6,127,058, U.S. Pat. No. 6,387,559, U.S. Pat. No. 6,497,975, and U.S. Pat. No. 6,465,119. The fuel cells with such a design could be suitable for thinner and smaller space, which is more convenient for compact electronic product, such as cellular phone, PDA, or notebook computer, and has lower requirement of association for the peripheral system. The advantage of easily manufacturing is greatly improved for the stacked design. However, the fuel cell with such design has lower power generation power.

The American Patent No. U.S. Pat. No. 5,631,099, titled “Surface Relica Fuel Cell”, has disclosed the fuel cell employing both stacked and plane-type design; in other words, U.S. Pat. No. 5,631,099 could combine the advantages of stacked and pallet-type design, so as to increase the power generation efficiency for fuel cell, and provide the advantages of lighter weight, convenient usage, and lower space limitation. Nevertheless, U.S. Pat. No. 5,631,099 still have some disadvantages, such as complicated structure not easy to manufacture, not easy to eliminate the reaction product (ex. water), not easy to supply the air or oxygen.

The inventor of the present invention has been in view of the defects in the prior art, and worked on the improvement to create a layer lamination integrated fuel cell, which is to employ the design parameters supplying electricity power, and manufacture the layer lamination integrated fuel cell compliant with these parameters; and, the layer lamination integrated fuel cell system according to the present invention could provide the advantages of easy to manufacture, lower cost, light weight, convenient usage, and lower space limitation.

### SUMMARY OF THE INVENTION

The first object of the present invention is to provide a layer lamination integrated fuel cell, which could easily realize a light, slim, short and compact fuel cell.

The second object of the present invention is to provide a layer lamination integrated fuel cell, which could employ the design parameters supplying electricity power, and manufacture the layer lamination integrated fuel cell compliant with the parameters.

To this end, the present invention provides a layer lamination integrated fuel cell, which comprises: two sheets of plate-structure one-sided cathode flow field boards, at least one sheet of plate-structure two-sided cathode flow field board, at least one sheet of plate-structure two-sided anode flow field board, and, at least one sheet of plate-structure bipolar fuel cell boards; in which, the two sheets of one-sided cathode flow field boards are configured on the both outmost sides of the layer lamination integrated fuel cell; these two-sided cathode flow field boards are configured between the layer lamination integrated fuel cell in separated layers; these two-sided anode flow field boards are configured between the layer lamination integrated fuel cell in separated layers; and, these bipolar fuel cell boards are configured between the layer lamination integrated fuel cell in separated layers. The side surfaces configured at the cathode of the outmost two sheets of bipolar fuel cell boards for the layer lamination integrated fuel cell are tightly bonded with two sheets of one-sided cathode flow field boards, respectively; and, the side surfaces configured at the cathode in layers of other bipolar fuel cell boards for the layer lamination fuel cell are tightly bonded with each sheet of two-sided cathode flow field board, respectively; and, the side surfaces of the anode for these layered bipolar fuel cells are tightly bonded with each sheet of two-sided anode flow field board, respectively.

### BRIEF DESCRIPTION OF THE DRAWINGS

The present invention would be detailed described in the following to make the skilled in the art understand the object, features and effects of the present invention through the following embodiments and the attached figures, wherein:

FIG. 1 is a structural diagram of layer lamination integrated fuel cell according to the present invention;

FIG. 2 is an exploded view of layer lamination integrated fuel cell for an embodiment according to the present invention;

FIG. 3 is an exploded view of a bipolar fuel cell board according to the present invention;

FIG. 4 is a three-dimensional diagram of a one-sided cathode flow field board with anode fuel inlet/outlet according to the present invention;

FIG. 5 is a three-dimensional assembly diagram of a one-sided cathode flow field board according to the present invention;

FIG. 6 is a three-dimensional assembly diagram of a two-sided cathode flow field according to the present invention; and

FIG. 7 is a three-dimensional assembly diagram of a two-sided anode flow field board according to the present invention.

### DETAILED DESCRIPTION OF THE INVENTION

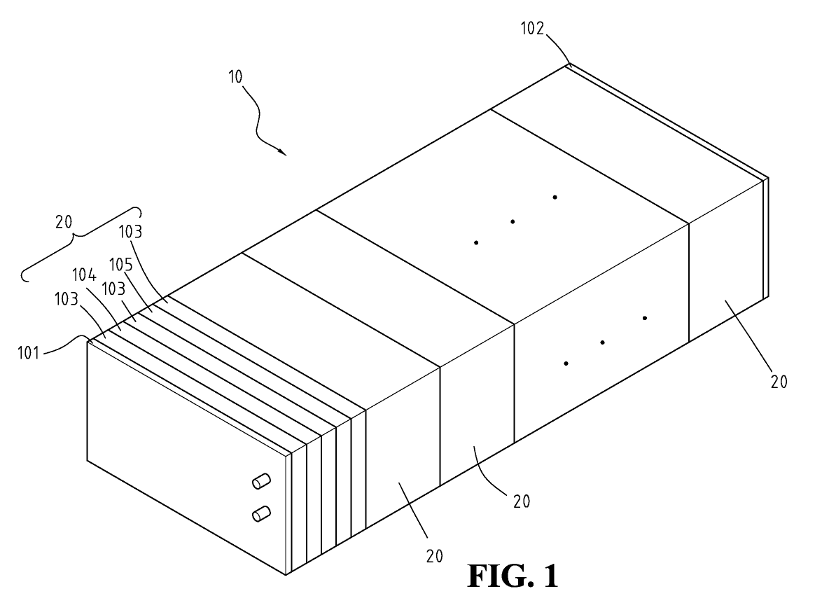

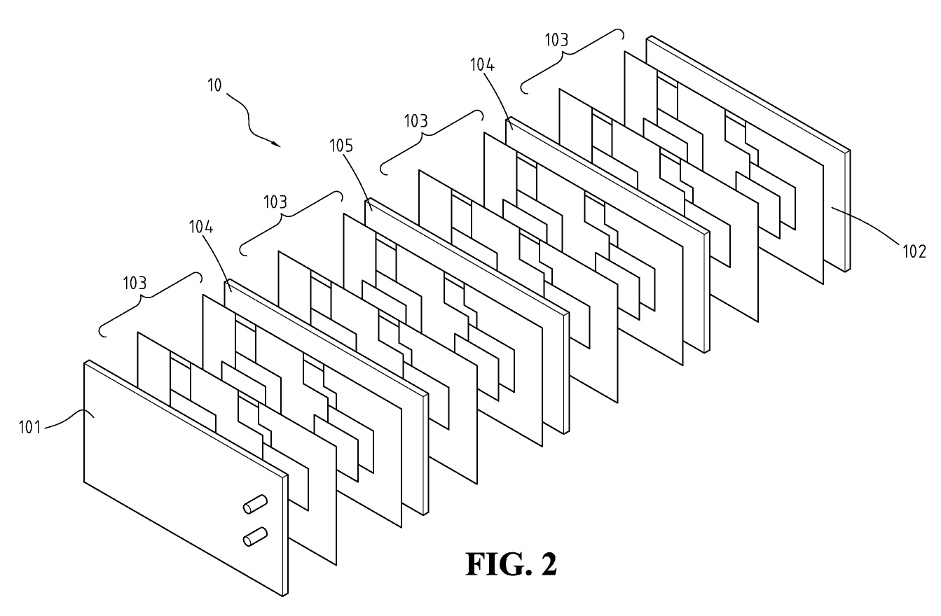

FIG. 1 is a structural diagram of layer lamination integrated fuel cell according to the present invention, and FIG. 2 is an exploded view of layer lamination integrated fuel cell for an embodiment according to the present invention. The layer lamination integrated fuel cell (10) according to the present invention comprises: two sheets of plate-structure one-sided cathode flow field boards (101), (102), at least one sheet of plate-structure two-sided anode flow field board (104), at least one sheet of plate-structure two-sided cathode flow field board (105), and at least one sheet of plate-structure bipolar fuel cell board (103), and, these members are stacked and tightly bonded as one sheet of single-pallet structure, as shown in FIG. 1. The following will explain each member in FIG. 1.

In FIG. 1, the present invention defines a fuel cell assembly unit (20), which is sequentially composed of first sheet of bipolar fuel cell board (103), one sheet of two-sided anode flow field board (104), second sheet of bipolar fuel cell board (103), one sheet of two-sided cathode flow field board (105), third sheet of bipolar fuel cell board (103). The assembly method of layer lamination integrated fuel cell according to the present invention is to employ the requirement for supplying electricity power to stack a plurality of fuel cell assembly units (20) satisfied with the requirement; and, separately stacking the one-sided cathode flow field boards (101), (102) on the outmost two side faces, and employing the pressing means to tightly bond each stacked member.

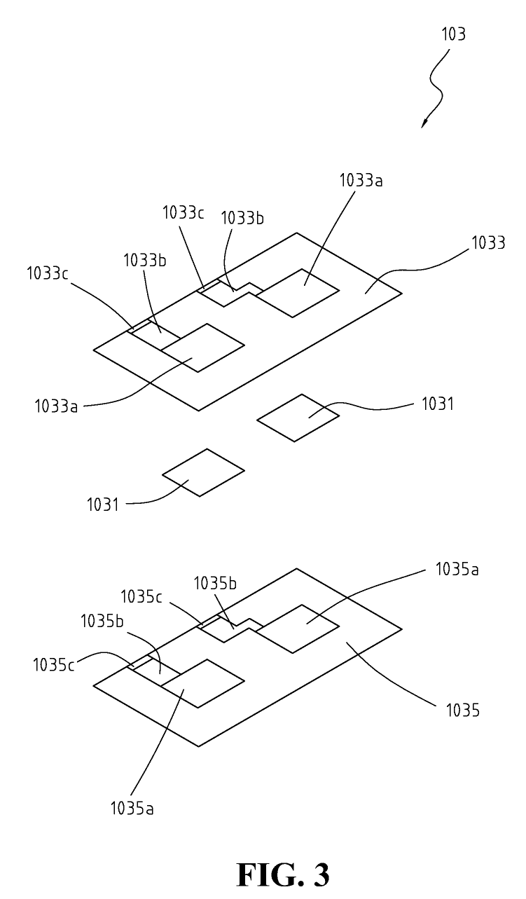

FIG. 3 is an exploded view of bipolar fuel cell board according to the present invention, in which a plurality of sheets of bipolar fuel cell boards (103) are configured between the layer lamination integrated fuel cell (10) in separated layers. The bipolar fuel cell board (103) comprises: one sheet of cathode cover plate (1033), at least one membrane electrode assembly (1031), and one sheet of anode cover plate (1035); and, these membrane electrode assemblies (1031) are sandwiched and fixed between the cathode cover plate (1033) and anode cover plate (1035); and, the cathode cover plate (1033) is configured with at least one opening (1033a), and the configured amount of these openings (1033a) is determined by the amount of these membrane electrode assemblies (1031); and, the area of the opening (1033a) is slightly smaller than the area of the membrane electrode assembly (1031). Similarly, the anode cover plate (1035) is configured with at least one opening (1035a), and the configured amount of these openings (1035a) is determined by the amount of these membrane electrode assemblies (1031), and the area of the opening (1035a) is slightly smaller than the area of the membrane electrode assembly (1031).

In FIG. 3, the surface of the cathode cover plate (1033), optionally on the upper surface or the lower surface or both, is configured with the circuitries (1033b); wherein, ends of these circuitries (1033b) are electrically connected to the cathodes of these correspondingly membrane electrode assemblies (1031), and the other ends are connected to the corresponding cathode pads (1033c), and the cathode pads (1033c) are configured on the edge of the cathode cover plate (1033). Similarly, the surface of the anode cover plate (1035), optionally on the upper surface or the lower surface or both, is configured with the circuitries (1035b); wherein, the ends of these circuitries (1035b) are electrically connected to the anodes of these correspondingly membrane electrode assemblies (1031), and the other ends are connected to the corresponding anode pads (1035c), and the anode pads (1035c) are configured on the edge of the anode cover plate (1035).

The substrate for cathode cover plate (1033) and anode cover plate (1035) could be selected from one of anti-chemical non-conductive engineering plastic substrate, plastic carbon substrate, FR4 substrate, FR5 substrate, epoxy resin substrate, fiber-glass substrate, ceramic substrate, polymer plasticized substrate, composite material substrate, and printed circuit substrate.

The embodiment of membrane electrode assembly (1031) according to the present invention could employ the associated prior art, such as directly employing the direct methanol membrane electrode assembly made of proton exchange membrane.

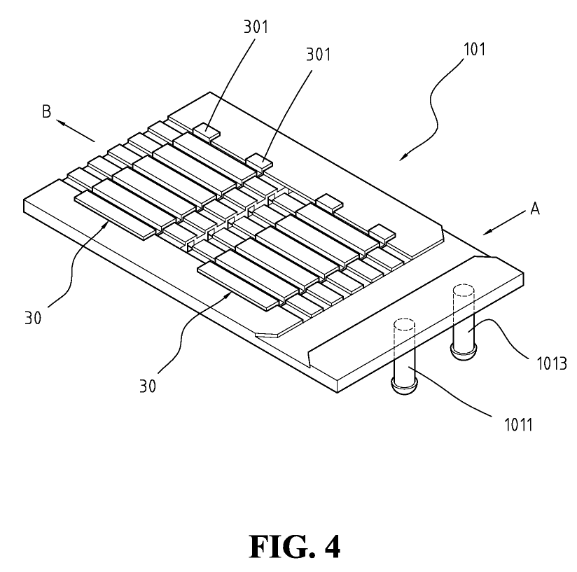

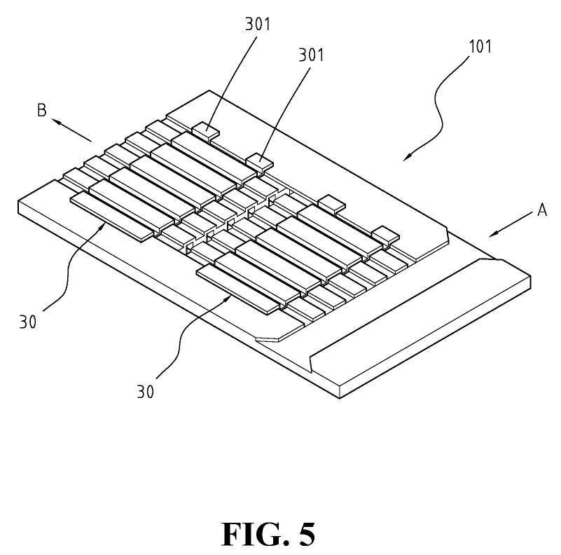

FIG. 4 is a three-dimensional diagram of one-sided cathode flow field board with anode fuel inlet/outlet according to the present invention, and FIG. 5 is a three-dimensional diagram of one-sided cathode flow field board according to the present invention; wherein, two sheets of one-sided cathode flow field boards (101), (102) are configured on the two outmost sides of the layer lamination fuel cell (10), respectively; and, the surface of the one-sided cathode flow field boards (101), (102) with channel structure is tightly bonded with the surface of the cathode for the bipolar fuel cell board (103). The one-sided cathode flow field boards (101), (102) could be configured as plate structure, and dug with a plurality of parallel slots on the surface of plate body to form the channel for cathode fuel, such as air. The external air could be introduced as the arrow A (referring to arrow label A in FIG. 4 and FIG. 5), and the inlet area of the one-sided cathode flow field boards (101), (102) could be dug with a small area of recessed area to make the air smoothly introduced. The air could flow in these slots, and enter these cathodes of the bipolar fuel cell board (103). Finally, the remaining air and cathode product will flow out from the arrow B (referring to arrow label B in FIG. 4 and FIG. 5).

In FIG. 4, the lower surface of the one-sided cathode flow field board (101) is configured with an anode fuel inlet (1011) and an anode fuel outlet (1013). The external anode fuel, such as methanol aqueous solution, could flow into the layer lamination integrated fuel cell (10) from the anode fuel inlet (1011); then, the anode fuel will flow to each sheet of two-sided anode flow field board (104); finally, the remaining anode fuel and anode product will flow out from the anode fuel outlet (1013).

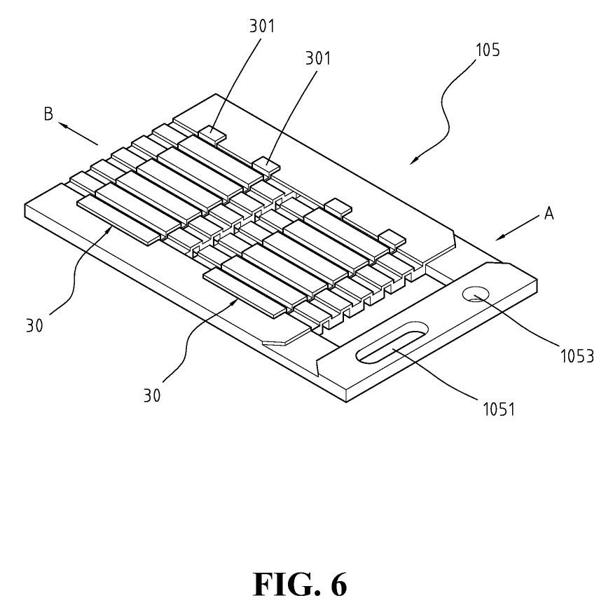

FIG. 6 is a three-dimensional diagram of two-sided cathode flow field board according to the present invention; in which, the plurality of sheets of two-sided cathode flow field boards (105) are configured between the layer lamination fuel cell (10) in separated layers. The upper surface of the two-sided cathode flow field board (105) is tightly bonded with the surface with the cathode for the bipolar fuel cell board (103), and the lower surface of the same sheet of two-sided cathode flow field board (105) is tightly bonded with the surface with the cathode of another sheet of bipolar fuel cell board (103). The two-sided cathode flow field board (105) could be configured as plate structure, and the upper surface and the lower surface of the plate body are dug with a plurality of parallel slots respectively to form the channel for cathode fuel, such as air. The external air could be introduced from the arrow A (referring to arrow label A in FIG. 6). Each inlet area of the upper and lower surfaces for the two-sided cathode flow field board (105) are dug with recessed area, hollow area and recessed area adjacently, so as to make the air smoothly introduced. The air could flow in these slots, and enter these cathodes of the bipolar fuel cell board (103). Finally, the remaining air and cathode product will flow out from the arrow B (referring to arrow label B in FIG. 6).

The first through-hole (1051) and second through-hole (1053) of the two-sided cathode flow field board (105) are corresponded to the anode fuel inlet (1011) and the anode fuel outlet (1013) of the one-sided cathode flow field board (101), respectively, and also corresponded to the shunt portion (1041) and the outlet hole (1043) of the two-sided anode flow field board (104). Thus, for the structure of layer lamination integrated fuel cell (10) stacked with multiple sheets of pallet bodies according to the present invention, a single anode fuel inlet (1011), a plurality of first through-holes (105 1), and a plurality of shunt portions (1041) are connected as a small space; and, a single anode fuel outlet (1013), a plurality of second through-holes (1053), and a plurality of outlet holes (1043) are connected as another small space.

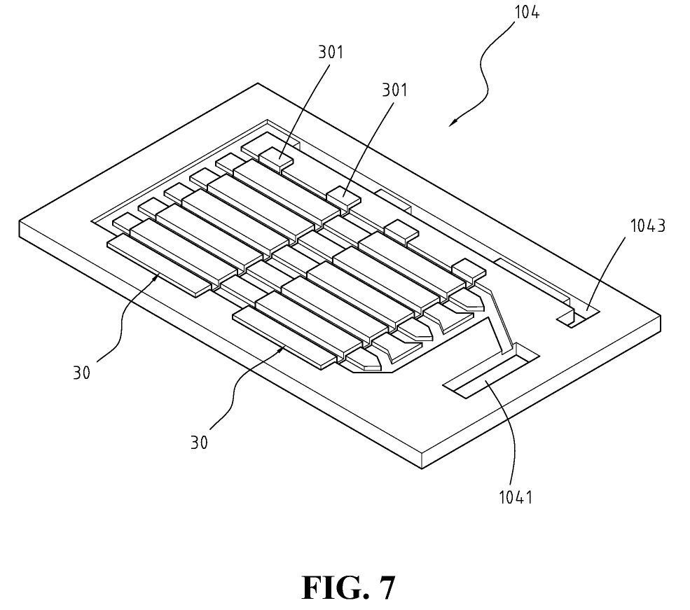

FIG. 7 is a three-dimensional of two-sided anode flow field board according to the present invention; in which, a plurality of sheets of two-sided anode flow field boards (104) are configured between the layer lamination fuel cell (10) in separated layers. The upper surface of the two-sided anode flow field board (104) is tightly bonded with the surface with the anode of the bipolar fuel cell board (103), and the lower surface of the same two-sided anode flow field board (104) is tightly bonded with the surface with the anode of another bipolar fuel cell board (103). The two-sided anode flow field board (104) could be configured as plate structure, and the upper and lower surfaces of the plate body are dug with a plurality of slots and a plurality of strip-holes, so as to form the channel for the anode fuel, such as methanol aqueous solution.

The shunt portion (1041) and the outlet hole (1043) of the two-sided anode flow field board (104) are the hollow structures. The external anode fuel from the anode fuel inlet (1011) could flow in the first through-hole (1051) of the two-sided cathode flow field board (105) on each layer, and the shunt portion (1041) of the two-sided anode flow field board (104) on each layer; then, the anode fuel flowing into the shunt portion (1041) of the two-sided anode flow field board (104) on each layer will flow to the inner channel of the two-sided anode flow field board (104) on each layer, and enter these anodes of the bipolar fuel cell board (103); finally, the remaining anode fuel and anode product for the two-sided anode flow field board (104) on each layer will flow to the outlet hole (1043) on each layer, and through the second through-hole (1053) of the two-sided cathode flow field board (105) on each layer; and, flowing out to the outside from the anode fuel outlet (1013).

The one-sided cathode flow field boards (101), (102), the two-sided cathode flow field board (105), the two-sided anode flow field board (104) are configured with a plurality of current collection sheets (30) respectively, and the current collection sheets (30) are used to contact with the cathode or anode of corresponding bipolar fuel cell board (103), and the current collection sheets (30) are tightly fixed on the one-sided cathode flow field boards (101), (102), the two-sided cathode flow field board (105), and the two-sided anode flow field board (104), respectively. These electricity collection sheets (30) could be provided with at least one flange (301), and these flanges (301) are electrically connected to the corresponding circuitries (1033b), (1035b). The material of the current collection sheet (30) is a conductive material, and also an anti-chemical material with anti-erosion and/or anti-acid properties, for example, selection one from the stainless steel (SUS316) sheet, gold foil, titanium metal, graphite material, carbon metal composite material, metal alloy sheet, and polymer conductive sheet with low impedance.

The substrate for the one-sided cathode flow field boards (101), (102), the two-sided cathode flow field board (105), and the two-sided anode flow field board (104) could be selected one from anti-chemical non-conductive engineering plastic substrate, graphite substrate, metal substrate, plastic carbon substrate, FR4 substrate, FR5 substrate, epoxy resin substrate, fiber-glass substrate, ceramic substrate, polymer plasticized substrate, and composite material substrate.

The layer lamination integrated fuel cell (10) according to the present invention could flexibly adjust the configured amount of fuel cell assembly units (20) based on the supplied electricity power, which is one of the advantages in the present invention. Moreover, the anode fuel outlet/inlet of the layer lamination fuel cell (10) according to the present invention employ the design of single-inlet and single-outlet, which could greatly simplify the supply structure for anode fuel, and is one of the advantages in the present invention. Because the present invention employs a layer lamination structure, the present invention could easily implement a light, slim, short and compact fuel cell, which is one of the advantages in the present invention.

Although the embodiments according to the present invention have been disclosed as above, these disclosed embodiments are not used to limit the present invention. The skilled in the art could have various modification and changes without departing from the spirit and scope of the present invention, and these modification and changes are all within the scope of the present invention. The protected scope for the present invention should be based on the attached claims.

What is claimed is:

1. A layer lamination integrated fuel cell, comprises:
two sheets of plate-structure one-sided cathode flow field boards (101), (102), which are configured on the two outmost sides of the layer lamination integrated fuel cell (10), respectively;
at least one sheet of plate-structure two-sided cathode flow field board (105), which is configured between the layer lamination integrated fuel cell (10) in separated layers;
at least one sheet of plate-structure two-sided anode flow field board (104), which is configured between the layer lamination integrated fuel cell (10) in separated layers;
at least one sheet of plate-structure bipolar fuel cell board (103), in which the side surfaces with the cathode configured on the two outmost bipolar dual fuel pallets (103) of the layer lamination integrated fuel cell (10) are tightly bonded with two sheets of one-sided cathode flow field boards (101), (102), respectively; and
wherein, the side surfaces with the cathode configured on the other bipolar fuel cell boards (103) in layers for the layer lamination integrated fuel cell (10) are tightly bonded with each sheet of two-sided cathode flow field board (105), and, the side surfaces with the anode configured on the layered bipolar fuel cell boards (103) are tightly bonded with each sheet of two-sided anode flow field board (104).

2. The layer lamination integrated fuel cell according to claim 1, wherein the bipolar fuel cell board (103) comprises: a cathode cover plate (1033), at least one membrane electrode assembly (1031), and an anode cover plate (1035), in which the membrane electrode assemblies (1031) are fixed in layers between the cathode cover plate (1033) and the anode cover plate (1035).

3. The layer lamination integrated fuel cell according to claim 2, wherein the cathode cover plate (1033) comprises at least one opening (1033a), and the openings (1033a) are corresponding to the membrane electrode assemblies (1031), respectively.

4. The layer lamination integrated fuel cell according to claim 2, wherein the anode cover plate (1035) comprises at least one opening (1035a), and the openings (1035a) are corresponding to the membrane electrode assemblies (1031), respectively.

5. The layer lamination integrated fuel cell according to claim 2, wherein the cathode cover plate (1033) comprises: at least one circuitry (1033b) configured on the surface of the cathode cover plate (1033), in which the circuitries (1033b) are electrically connected to the cathodes of the corresponding membrane electrode assemblies (1031).

6. The layer lamination integrated fuel cell according to claim 2, wherein the anode cover plate (1035) comprises: at least one circuitry (1035b) configured on the surface of the anode cover plate (1035), in which the circuitries (1035b) are electrically connected to the anodes of the corresponding membrane electrode assemblies (1031).

7. The layer lamination integrated fuel cell according to claim 1, wherein the one-sided cathode flow field board (101) is further configured with an anode fuel inlet (1011), and an anode fuel outlet (1013), in which the anode fuel inlet (1011) and the anode fuel outlet (1013) are used as a single inlet/outlet for the anode fuel used by the layer lamination integrated fuel cell (10).

8. The layer lamination integrated fuel cell according to claim 2, wherein the substrate for the cathode cover plate (1033) is selected one from an anti-chemical non-conductive engineering plastic substrate, a plastic carbon substrate, a FR4 substrate, a FR5 substrate, an epoxy resin substrate, a fiber-glass substrate, a ceramic substrate, a polymer plasticized substrate, a composite material substrate, a printed circuit substrate.

9. The layer lamination integrated fuel cell according to claim 2, wherein the substrate for the anode cover plate (1035) is selected one from an anti-chemical non-conductive engineering plastic substrate, a plastic carbon substrate, a FR4 substrate, a FR5 substrate, an epoxy resin substrate, a fiber-glass substrate, a ceramic substrate, a polymer plasticized substrate, a composite material substrate, a printed circuit substrate sheet.
